(19) United States
(12) Patent Application Publication
(10) Pub. No.: US 2022/0230480 A1
(43) Pub. Date: Jul. 21, 2022

(54) VEHICLE MONITORING DEVICE, RELAY, EMERGENCY ARBITRATION DEVICE AND VEHICLE EMERGENCY MONITORING SYSTEM

(71) Applicant: Sony Group Corporation, Tokyo (JP)

(72) Inventor: Samuel Asangbeng ATUNGSIRI, Basingstoke (GB)

(73) Assignee: Sony Group Corporation, Tokyo (JP)

(21) Appl. No.: 17/609,793

(22) PCT Filed: Jun. 4, 2020
(86) PCT No.: PCT/EP2020/065414

§ 371 Date: Nov. 9, 2021

(30) Foreign Application Priority Data
Jun. 6, 2019 (EP) 19178855.3

(51) Int. Cl. G07C 5/00; H04B 7/26

(52) U.S. Cl. CPC G07C 5/008; H04B 7/2606

(57) ABSTRACT

A vehicle monitoring device has circuitry configured to communicate with a remote computer through a mobile telecommunications system, wherein the circuitry is further configured to: transmit vehicle monitoring data to a remote computer, wherein the vehicle monitoring data are transmitted via a relay of the mobile telecommunication system located at the vehicle.

### TECHNICAL FIELD

The present disclosure generally pertains to a vehicle monitoring device, a relay, an emergency arbitration device and a vehicle emergency monitoring system.

### TECHNICAL BACKGROUND

General, several generations of mobile telecommunications systems are known, e.g. the third generation (“3G”), which is based on the International Mobile Telecommunications-2000 (IMT-2000) specifications, the fourth generation (“4G”), which provides capabilities as defined in the International Mobile Telecommunications-Advanced Standard (IMT-Advanced Standard), and the current fifth generation (“5G”), which is under development and which might be put into practice in the year 2020.

A candidate for providing the requirements of 5G is the so-called Long Term Evolution (“LTE”), which is a wireless communications technology allowing high-speed data communications for mobile phones and data terminals and which is already used for 4G mobile telecommunications systems. Other candidates for meeting the 5G requirements are termed New Radio (NR) Access Technology Systems (NR).

LTE is based on the GSM/EDGE (“Global System for Mobile Communications”/“Enhanced Data rates for GSM Evolution” also called EGPRS) of the second generation (“2G”) and UMTS/HSPA (“Universal Mobile Telecommunications System”/“High Speed Packet Access”) of the third generation (“3G”) network technologies.

LTE is standardized under the control of 3GPP (“3rd Generation Partnership Project”) and there exists a successor LTE-A (LTE Advanced) allowing higher data rates than the basic LTE and which is also standardized under the control of 3GPP.

For the future, 3GPP plans to further develop LTE-A such that it will be able to fulfill the technical requirements of 5G.

As the 5G system may be based on LTE-A or NR, respectively, it is assumed that specific requirements of the 5G technologies will, basically, be dealt with by features and methods which are already defined in the LTE-A and NR standard documentation.

Moreover, it is generally known to provide mobile telecommunication via satellites and, thus, it is expected that satellites will also be used in 5G networks. Such satellites from part of the 5G non-terrestrial networks (NTN). These are networks, or segments of networks, which can be based on airborne or space-borne vehicles for mobile transmission, wherein user equipment (UE) or other module which is adapted to communication on the mobile telecommunications network accesses the base-station (gNB) via a space-borne or air-bone platform such as a satellite. Aerial UEs can also access the NTN and can operate, for example, between 8 and 50 km, and may even be quasi-stationary.

Non-terrestrial networks are, for example, specified in TSG RAN's TR38.811 “Study on NR to support non-terrestrial networks”.

The advent of NTN-based 5G networks may provide a broadband communication network with at least one of the following characteristics:
High capacity communication links
Operations with UEs and relays travelling at high speed
Ubiquitous (global) coverage
High outdoor availability and reliability

Moreover, flight data recorder (FDR) or similar systems are known, which store relevant data, in order to assist the analysis of an accident or incident of an aircraft. Typically, such FDRs are built to resist extreme situations and include a transmitter, such as an underwater locator beacon.

Although there exist techniques for flight data recording, it is generally desirable to provide a vehicle monitoring device, a relay, an emergency arbitration device and a vehicle emergency monitoring system.

### SUMMARY

According to a first aspect, the disclosure provides a vehicle monitoring device, comprising circuitry configured to communicate with a remote computer through a mobile telecommunications system, wherein the circuitry is further configured to transmit vehicle monitoring data to a remote computer, wherein the vehicle monitoring data are transmitted via a relay of the mobile telecommunication system located at the vehicle.

According to a second aspect, the disclosure provides a relay comprising circuitry configured to communicate with a mobile telecommunications system, wherein the circuitry is further configured to establish a mobile communication backhaul link to the mobile telecommunications system; provide mobile telecommunication to a vehicle monitoring device and at least one user equipment located at the vehicle; and transmit vehicle monitoring data received from the monitoring device and transmission data received from the at least one user equipment to the mobile telecommunications system over the backhaul link.

According to a third aspect, the disclosure provides an emergency arbitration device comprising circuitry configured to receive emergency sensor data from at least one emergency sensor mounted at a vehicle; generate an emergency command based on the received sensor data; and provide the emergency command, such that the relay prioritizes vehicle monitoring data for transmission over a backhaul link established to a mobile telecommunications system.

According to a fourth aspect, the disclosure provides a vehicle emergency monitoring system, comprising a vehicle monitoring device, comprising circuitry configured to communicate with a mobile telecommunications system, wherein the circuitry is further configured to: transmit vehicle monitoring data to a remote computer, wherein the vehicle monitoring data are transmitted via a relay of the mobile telecommunication system located at the vehicle; and the relay comprising circuitry configured to communicate with a mobile telecommunications system, wherein the circuitry is further configured to: establish a mobile communication backhaul link to the mobile telecommunications system; provide mobile telecommunication to the vehicle monitoring device and at least one user equipment located at the vehicle; and transmit vehicle monitoring data received from the monitoring device and transmission data received from the at least one user equipment to the mobile telecommunications system over the backhaul link.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 is a block diagram illustrating an embodiment of a vehicle emergency monitoring system;

FIG. 2 is a state diagram illustrating the functions of the vehicle emergency monitoring system of FIG. 1;

FIG. 3 is a block diagram of a vehicle monitoring device, a relay and an emergency arbitration device; and

FIG. 4 is a block diagram of a multi-purpose computer which can be used to implement a vehicle monitoring device, a relay and an emergency arbitration device.

### DETAILED DESCRIPTION OF EMBODIMENTS

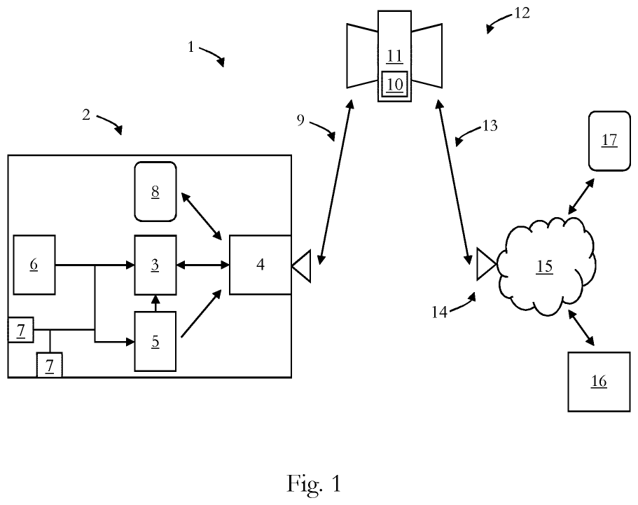

Before a detailed description of the embodiments under reference of FIG. 1 is given, general explanations are made.

As also mentioned in the outset, a 5G system may be based on LTE-A or NR. Moreover, in some embodiments, mobile telecommunication is provided via non-terrestrial networks based on satellites, which may be part of a 5G network. Additionally, non-terrestrial networks (NTN) may be used in some embodiments. With NTNs the UEs may be based on airborne or spaceborne vehicles, wherein such airborne or spaceborne vehicles may include, for example, a user equipment (UE) or other module which is adapted to communication with the NTN mobile telecommunications network. Aerial UEs may operate, for example, between 8 and 50 km, and may even be quasi-stationary.

The roll out of NTN-based 5G systems will provide in some embodiments a ubiquitous broadband network that covers, for example, the entire globe.

It has been recognized that the availability of such a network, e.g. an NTN, may also allow the ability to backhaul for home station storage and analysis any critical telemetry data from long distance transport vehicles such as airplanes, ships and trains.

Moreover, it has been recognized that there is need for critical systems monitoring in long distance transport vehicles such as airplanes, ships and trains. The data derived from such monitoring can be, e.g., used for:
Routine diagnosis and maintenance for fault preemption once the vehicle returns to its home station
Investigate accidents that the vehicle has been involved in, without limiting the present disclosure in that regard.

However, because there is no ubiquitous communications network capable of providing coverage everywhere, in some embodiments, the vehicle goes for backhauling the data that results from the monitoring, such critical operational systems data tends to be recorded and stored onboard, as also indicated in the outset. This is often stored in secure and hard to destroy storage devices known variously as black box recorder (BBR), cockpit voice recorder (CVR), flight recorders etc. The rationale is that when the vehicles return to base or suffer catastrophic accidents, the storage devices can be recovered and the information retrieved for analysis.

There have been recent cases in which:
It took a rather long time to recover the flight recorders thereby impeding speedy retrieval and analysis of the stored data. An example of this is the case of Air France's flight AF447 from Rio de Janeiro to Paris which crashed in the Atlantic Ocean in June 2009 and it took until May 2011 to recover the flight recorders.
The flight recorders are destroyed from the impact of the crash or by any ensuing fires. For example, the case for at least some of the flight recorders for the planes that were crashed into the WTC towers on 9/11. Even though the storage devices are hardened and made to be very resilient, they can still be destroyed in intense fires or high impact crashes.
The airplane was lost and so the flight recorders have never been found—for example the case of MH370 which was lost over the Indian Ocean in March 2014 and the flight recorders have never been found.

It has further been recognized that with ubiquitous NTN-based 5G coverage, long distance transport vehicles typically will carry an NTN relay, as also further discussed below.

Consequently, some embodiments pertain to a vehicle monitoring device, having circuitry configured to communicate with a remote computer through a mobile telecommunications system, wherein the circuitry is further configured to transmit vehicle monitoring data to a remote computer, wherein the vehicle monitoring data are transmitted via a relay of the mobile telecommunication system located at the vehicle.

The vehicle monitoring device can be or be part of a flight data recorder (FDR), black box recorder (BBR), cockpit voice recorder (CVR) or the like. It may also include at least one of a FDR, BBR, CVR.

The vehicle monitoring device can also be part of an electronic device of a vehicle, such as an onboard computer, emergency recorder, or the like.

The circuitry may include at least one of: a processor, a microprocessor, a dedicated circuit, a memory, a storage, a radio interface, a wireless interface, a network interface, or the like, e.g. typical electronic components which are included in a base station, such as an eNodeB, NR gNB, a user equipment, or the like. It may include an interface, such as an mobile telecommunications system interface which is adapted to provide communication to and/or from the mobile telecommunications system, which may be based on UMTS, LTE, LTE-A, or on an NR, 5G system or the like and which may also be or be part of an NTN, which, in turn, may be based on 5G NR, 5G NTN, etc. It may also include a wireless interface, e.g. a wireless local area network interface, a Bluetooth interface, etc.

The circuitry transmits vehicle monitoring data to a computer which may be also on-board the vehicle, wherein the vehicle monitoring data are transmitted via a relay of the mobile telecommunications system, wherein the relay is located at the vehicle which may be an aircraft, a ship, a train, a drone, a submarine, a bus, or a coach.

The vehicle monitoring data may not be directly transmitted to the on-board computer, but wirelessly to the relay, which then transmits them wirelessly via satellite or NTN or the like, to the remote computer.

The remote computer may be used for storing the vehicle monitoring data, for monitoring it and, thus, for monitoring a status of the vehicle, for further analysis of an accident or incident of the vehicle, etc.

A relay may be an integrated access-backhaul (IAB) relay. IAB relays may behave such as an user equipment (UE) when observed from a next generation base station gNB (which may also be referred to as donor gNB) to which they backhaul their traffic. The IAB may behave as a gNB when viewed from a UE which accesses the network through the IAB relay. In this case, the donor gNB to the vehicle IAB relay is, for example, an NTN gNB located either at or beyond an NTN satellite or any other entity of the mobile telecommunications system.

The vehicle monitoring data may include at least one of: sensor data from vehicle sensors, voice recording data, positioning data, image data, or the like. For instance, the vehicle monitoring data may be indications of flight parameters (or train/ship driving parameters), including control and actuator positions of the vehicle, engine information, time of day, temperature (indoor, engine, outdoor, critical components), pressure (outside, inside the vehicle), voltage parameters (e.g. of an on-board electric grid, etc.).

Hence, in some embodiments, by transmitting the vehicle monitoring data to the remote computer, the vehicle monitoring data are accessible at the remote computer even in cases where the vehicle monitoring device (e.g. integrated in an FDR, BBR, etc.) cannot be found, is damaged, etc.

In some embodiments, the vehicle monitoring data are transmitted continuously or periodically or on command via the relay to remote computer, and, thus, to the remote computer. Thereby, for example, a data transmission rate can be controlled and the transmission rate can be tailored to a specific situation of the vehicle (e.g. emergency situation, critical situation of the vehicle, etc.), to transmission capacities or qualities, etc.

In some embodiments, the vehicle monitoring data are transmitted in response to a transmission command to transmit the vehicle monitoring data. The transmission command can include one or more bits of digital data and it may be a single command or it may also be integrated in another command or data word.

In some embodiments, the transmission command is received from the relay, i.e. over a wireless link to the relay (which may be configured as an access link in accordance with the Uu interface in 5G).

In some embodiments, the transmission command is issued by the relay. This can be done by the relay in response to a respective command received from another entity or the by the relay itself, e.g. based on a data transmission capacity or the like.

In some embodiments, wherein the transmission command is issued by a remote computer. Thereby, for example, the remote computer can control whether, when, and in which detail vehicle monitoring data can be transmitted to the remote computer. For instance, in cases where a critical situation (emergency situation, etc.) of the vehicle is detected, the remote computer (or a personnel having control over the remote computer) can trigger to issue the command to be sent to the vehicle monitoring device.

In some embodiments, the transmission command includes an emergency command issued by an emergency arbitration device on-board or off-board of the vehicle. For instance, if the emergency arbitration device detects a critical situation (emergency situation, etc.) of the vehicle from analysis of the monitoring data, it can trigger with the emergency command that the vehicle monitoring data are transmitted.

In some embodiments, the transmission command is issued by a vehicle-based device, e.g. an on-board computer or other electronic device of the vehicle. The vehicle-based device may be configured to transmit the transmission command by itself or in response to a user input (e.g. over a button, switch, software command, etc.).

In some embodiments, the circuitry is further configured to perform data compression on the vehicle monitoring data. The data compression may be lossy (e.g. for voice recording using audio compression techniques such as MP2, HE-AAC, MP3, etc.) or lossless based on known algorithms, such as Lempel-Ziv, ZIP (etc.) compression methods, algorithms, which are based on probabilistic models, or the like. Moreover, the type of the data compression may be adjusted, e.g., based on transmission capacities or capabilities, but also based on a state of the vehicle (e.g. normal, critical, emergency, etc.).

In some embodiments, the circuitry is configured to store the vehicle monitoring data until transmission of the vehicle monitoring data. For instance, if the data transmission is performed periodically or in circumstances when backhaul link capacity is inadequate because of reduced or no network coverage, the vehicle monitoring data may be stored for one or more periods. In such embodiments, the circuitry may include a data cache (e.g. a hard disk, solid-state-drive, or the like), wherein the capacity of the data cache is adapted to the transmission of the vehicle monitoring data, as discussed.

In some embodiments, the circuitry is further configured to divide the vehicle monitoring data into at least two vehicle monitoring data groups. The vehicle monitoring data groups may include vehicle monitoring data of different relevance, or the like.

In some embodiments, the circuitry is further configured to prioritize at least one of the at least two vehicle monitoring data groups for transmission, such that, for example, the transmission of vehicle monitoring data having a higher relevance is ensured.

In some embodiments, the circuitry transmits the prioritized vehicle monitoring data group based on a network access link quality to the relay. For instance, in bad access link quality situation, only the prioritized vehicle monitoring data group is transmitted, while in good access link quality situations, two, more or all groups of the vehicle monitoring data groups are transmitted.

In some embodiments, the circuitry transmits the prioritized vehicle monitoring data group in response to a prioritization command received from the relay or the remote computer. For instance, if the relay detects an emergency situation, e.g. from the emergency arbitration device, a specific backhaul link quality, or the like, the relay may transmit the prioritization command, such that, for example, in such a situation transmission of the, e.g. most important vehicle monitoring data is ensured (or at least of a prioritized vehicle monitoring data group).

Some embodiments pertain to a relay having circuitry configured to communicate with a mobile telecommunications system, wherein the circuitry is further configured to establish a mobile communication backhaul link to the mobile telecommunications system; provide mobile telecommunication to a vehicle monitoring device and at least one user equipment located within the vehicle; and transmit vehicle monitoring data received from the monitoring device and transmission data received from the at least one user equipment to the mobile telecommunications system over the backhaul link.

As discussed above, the relay may be an integrated access-backhaul (IAB) relay, and it is referred to in the discussion above in that regard. Hence, the relay may be configured to behave like a base station (e.g. an eNodeB, gNB, or the like) with respect to the UE in the vehicle and with respect to the vehicle monitoring device (when viewed from them in the direction of the relay) and it may behave such as a UE when observed from a base station, such as a next generation base station gNB to which it backhauls the traffic via the backhaul link. Thus, the relay may use the same frequency bands for the backhaul link as a UE inside the vehicle which is connected to to the relay as its gNB.

The circuitry of the relay may include at least one of: a processor, a microprocessor, a dedicated circuit, a memory, a storage, a radio interface, a wireless interface, a network interface, or the like, e.g. typical electronic components which are included in a base station, such as an eNodeB, NR gNB. It may include an interface, such as a mobile telecommunications system interface which is adapted to provide communication to and/or from the mobile telecommunications system, which may be based on UMTS, LTE, LTE-A, or on an NR, 5G system or the like and which may also be or be part of an NTN, which, in turn, may be based on NR, 5G, etc. It may also include a wireless interface, e.g. a wireless local network area interface, a Bluetooth interface, etc.

The relay may establish the (mobile communication) backhaul link to the mobile telecommunications system upon start, in response to a request from an entity (e.g. a UE, a base station, the remote computer, a device (e.g. on-board computer of the vehicle), etc.), periodically, at predetermined times, upon detection of a gNB of an NTN, etc.

The mobile telecommunication which is provided to the vehicle monitoring device and at least one user equipment located within the vehicle, may be initiated upon start, in response to a request from an entity (e.g. a UE, a base station, the remote computer, a device (e.g. on-board computer of the vehicle), etc.), periodically, at predetermined times, upon detection of a gNB of an NTN, etc.

The relay relays vehicle monitoring data received from the monitoring device and transmission data received from the at least one user equipment to the mobile telecommunications system over the backhaul link, as also discussed above. Hence, in some embodiments, the transmission of the vehicle monitoring data and/or of the transmission data of the at least one user equipment is transparent to the vehicle monitoring device and/or the at least one user equipment.

The mobile telecommunication connection to the vehicle monitoring device and/or to the at least one user equipment may be in accordance with any generation of mobile telecommunications system, but it may also be in accordance with other wireless transmission system, such as wireless local area network, Bluetooth, etc.

In some embodiments, the circuitry is further configured to prioritize the vehicle monitoring data for relay over the backhaul link, such that, for example, in specific cases it can be ensured that the vehicle monitoring data can be transmitted, for example, when the transmission capacity would not be sufficient for the transmission of the vehicle monitoring data together with transmission data of the at least one user equipment, the amount of vehicle monitoring data is too large, etc.

The prioritization may be performed on the basis of an emergency command. Thereby, it can be ensured that in specific situations or states of the vehicle the vehicle monitoring data is transmitted to the remote computer.

The emergency command may be received from an emergency arbitration device, which will also be discussed further below. The emergency arbitration device may be configured to detect a critical situation of the vehicle by analyzing the vehicle monitoring data and may send in response to this detection the emergency command to the relay, which acts accordingly as discussed.

The emergency command may be received from a vehicle (-based) device, such as an on-board computer, an emergency switch/button, etc., which may also be activated by personnel, e.g., driving the vehicle (e.g. a pilot of an aircraft, a captain of a ship, an engine driver of a train, etc.).

The prioritization may be performed on the basis of a backhaul link quality. The quality may describe a capacity, a connection stability, an error rate, signal strength, etc. Thereby, the transmission rate/capacity for the transmission of the vehicle monitoring data can be adapted accordingly by limiting the transmission for the transmission data of the at least one user equipment.

In some embodiments, the circuitry is further configured to limit transmission resources for the at least one user equipment, as also indicated above. In some embodiments, the prioritization involves also the limitation of transmission resources for the at least one user equipment during an emergency, as also indicated above.

In some embodiments, the circuitry is further configured to send a radio link control (RLC) command to the at least one user equipment for throttling down or stopping transmissions of the at least one user equipment. Thereby, the at least one user equipment may throttle or interrupt its data transmission, such that the deallocated capacities/resources can be used for the transmission of the vehicle monitoring data.

In some embodiments, the circuitry is further configured to switch a transmission configuration for the backhaul link. Thereby, for example, the security of the data transmission may be enhanced, such that, for example, a risk of data loss is reduced. The transmission configuration may include modulation and coding system (MCS) configurations or a data repetition configuration, which allow to ensure that the data various degrees of error-resilient transmission of the data to the remote computer.

The switching may be performed in response to an emergency command, which has been discussed above. Thereby, e.g. in a critical (emergency) situation of the vehicle the transmission of the vehicle monitoring data can be ensured or secured.

In some embodiments, the circuitry is further configured to transmit a transmission command to the vehicle monitoring device, which has also been discussed above. The transmission command may be transmitted in response to a command received from another entity (e.g. a vehicle (-based) device (on-board computer, emergency switch/button, etc.), the emergency arbitration device mentioned above, etc.

In some embodiments, the circuitry is further configured to transmit a prioritization command to the vehicle monitoring device, as also indicated above, such that the vehicle monitoring device may transmit prioritized vehicle monitoring data. Thereby, for example, in critical situations and/or in bad backhaul link quality situations, limited transmission resource situations, etc., at least prioritized vehicle monitoring data can be transmitted to the remote computer.

In some embodiments, the backhaul link is established to an entity of a non-terrestrial network, as discussed herein.

Some embodiments pertain to an emergency arbitration device having circuitry configured to receive emergency sensor data from at least one emergency sensor mounted at a vehicle; generate an emergency command based on (e.g. analysis of) the received sensor data; and provide the emergency command, such that the relay prioritizes vehicle monitoring data for transmission over a backhaul link established to a mobile telecommunications system. The emergency command may be provided (e.g. transmitted) to the vehicle monitoring device, which, in turn, then prioritizes the vehicle monitoring data transmission accordingly and/or, for examples, requests a prioritization of the vehicle monitoring data at the relay and/or the relay detects that it has to prioritize the transmission of the vehicle monitoring data, as discussed herein.

The emergency arbitration device may be an electronic device and it may be configured to be a “standalone device” or it may be included in another device, such as a security system of the vehicle, an on-board computer of the vehicle, etc. Moreover, in some embodiments, the emergency arbitration device is part of or integrated in the relay as discussed herein, while in other embodiments it is even integrated in the vehicle monitoring device.

The circuitry of the emergency arbitration device may include at least one of: a processor, a microprocessor, a dedicated circuit, a memory, a storage, a radio interface, a wireless interface, a network interface, or the like, e.g. typical electronic components which are included in a base station, such as an eNodeB, NR gNB, a user equipment, or the like. It may include an interface, such as an mobile telecommunications system interface which is adapted to provide communication to and/or from the mobile telecommunications system, which may be based on UMTS, LTE, LTE-A, or on an NR, 5G system or the like and which may also be or be part of an NTN, which, in turn, may be based on NR, 5G, etc. It may also include a wireless interface, e.g. a wireless local network area interface, a Bluetooth interface, etc.

The emergency sensor data may be indicative of a parameter of the vehicle (e.g. parameters of an actuator, engine, etc.), a state of the vehicle (e.g. critical state, emergency state, accident, incident, etc.), an environment parameter (e.g. fire, lightning, low barometric pressure, humidity, etc.), activation of an emergency switch/button or the like. The at least one emergency sensor may be configured to provide corresponding emergency sensor data, as discussed, and, thus, may include at least one of temperature sensor, pressure sensor, voltage sensor, strain sensor, humidity sensor, air pressure sensor, electric switch, etc., may include subsystems to detect excessive unusual speed, extended free-falling, excessive vibration, smoke/fire detectors, air pressure gradient sensors, extended unusual orientation of the vehicle, etc.

The arbitration device is configured to generate an emergency command, as discussed herein, based on the received sensor data. For instance, if a predetermined threshold of a value of a specific parameter is exceeded, which is represented by the emergency sensor data, a critical situation can be detected and the emergency command is generated. In other instances, the activation of an emergency actuator (switch, button or the like) is detected and in response the emergency command is generated.

The emergency command may include on or more bits, which are indicative that a critical situation for the vehicle is present and it may (e.g. additionally) include information about the critical situation and/or it may include instructions for other devices to perform a corresponding action.

The emergency arbitration device provides the emergency command to a relay as discussed herein, wherein the emergency command may be provided wireless and/or wired, or internal in the relay or the vehicle monitoring device, e.g. via an internal bus-system, as a software command or the like.

As also discussed above, the relay prioritizes vehicle monitoring data for transmission over a backhaul link established to a mobile telecommunications system.

In some embodiments, the circuitry in the emergency arbitration device is further configured to determine an emergency situation based on the received sensor data and wherein the emergency command is generated when an emergency situation is determined, as also indicated above.

The determination may be based on a decision matrix, which represents different parameters (thresholds) and indicates in which cases (e.g. different combinations of parameters) a critical (emergency) situation may be present or not. Moreover, the decision matrix may also be indicative of different classes of critical situations. The decision matrix may be based on a decision tree model, as it is generally known.

The decision matrix may be obtained based on machine learning, as it is generally known. For instance, based on a decision tree model, classifiers of different situations can be obtained which, in turn, can be used as input (training data) for an artificial neural network, such as a convolutional neural network, Bayesian neural networks or the like. The present disclosure is not limited in that regard and other machine learning algorithms may be used, such as support vector machines (SVM), decision tree based algorithms, etc.

In some embodiments, for example, where the vehicle is an aircraft, the decision matrix is obtained based on flight simulator data. For trains or ships train simulator or ship simulator data may be used.

In some embodiments, the decision matrix is adapted based on vehicle data, e.g. which is obtained during operation of the vehicle, operation in a test stand or the like. The vehicle data may include, for example, operation data of the vehicle, which are indicative of a status of the vehicle, such as engine temperature, electric board grid voltage, temperature of a cooling system, actuator data, etc.

In some embodiments, and as discussed, the circuitry is further configured to transmit the emergency command to the vehicle monitoring device.

Some embodiments pertain a vehicle emergency monitoring system having the vehicle monitoring device, the relay and/or the emergency arbitration device as discussed herein.

Returning to FIG. 1, there is illustrated, as a block diagram, an embodiment of a vehicle emergency monitoring system 1 for a vehicle 2, which is an aircraft in the present embodiment (without limiting the present disclosure to a vehicle being an aircraft).

The vehicle emergency monitoring system 1, which is referred to as VEMS 1 hereinafter, has vehicle monitoring device 3 (referred to as “VMD 3” hereinafter), as also discussed above, and a relay 4, as also discussed above.

The VEMS 1 has also an emergency arbitration device 5, referred to as EAD 5 hereinafter, as discussed above.

Moreover, in the aircraft 2, as vehicle device, an on-board computer 6 is provided, which typically is configured to perform an overall control of the vehicle and which can be operated by a pilot of the aircraft 2.

Furthermore, the EAD 5 is coupled to multiple emergency sensors 7, as discussed, wherein exemplary two emergency sensor 7 are depicted in FIG. 1. The emergency sensors 7 transmit emergency sensor data to the EAD 5, as discussed above. The emergency sensors 7 include in this embodiment exemplary subsystems that detect excessive unusual speed, extended free-falling, excessive vibration, smoke/fire detectors, air pressure gradient sensors, extended unusual orientation of the vehicle etc. When each such emergency detectors is triggered it outputs an emergency signal to the EAD 5.

Typically, passengers in the aircraft 2 may have user equipments UE, wherein FIG. 1 exemplary illustrates one UE 8.

The relay 4 establishes a backhaul link 9 to a non-terrestrial network gNB 10 included in a satellite 11 of a non-terrestrial network 12 which is based on 5G, as discussed above.

The gNB 10 establishes a backhaul link 13 to a gateway station 14 connected to the 5G core network 15 (which may be part of or connected to the NTN 12), to which a remote computer 16 (e.g. home station server) is connected (e.g. over a core network, the internet, etc.) and, exemplary depicted, (multiple) UEs 17.

In the present embodiment, the relay 4 is an integrated access-backhaul (IAB) relay. The relay 4 behaves like a UE when observed from the gNB 10 (also called donor gNB) to which it backhauls its traffic over the backhaul link 9 and it behaves as a gNB when viewed from the UEs 8 and the VMD 3 (and optionally the EAD 5) that access the NTN 12 through the relay 4.

As mentioned, in the present embodiment, the donor gNB to the vehicle relay 4 is the NTN gNB 10 located at the NTN satellite 11 (in other embodiments it may be located beyond the NTN gateway station 14).

The UEs 8 of passengers within the aircraft 2 can communicate with each other by using the gNB function of the relay 4. However, when a passenger wishes to communicate with a target UE that is not onboard of the aircraft 2, e.g. UE 17, such communications will be backhauled from the relay 7, via the satellite(s) 11 of the NTN 12 to the relay's donor NTN gNB 10 and beyond the donor gNB 10 to the core network (depicted also as cloud 15) and then unto the target UE 17.

In similar fashion, telemetry traffic arising from critical systems monitoring within the aircraft 2 can also travel as vehicle monitoring data from the VMD 3 on the backhaul link 9 to a server at the vehicle's home station having reference number 16 in FIG. 1.

As also mentioned above, the need for inflight recorders of such telemetry data can therefore be minimized or even eliminated in this embodiment, since all such critical system vehicle monitoring data are transmitted back to the home station 16 of the aircraft 2 for storage on servers of the home station 16.

As mentioned, the amount of vehicle monitoring data, e.g. including telemetry data, can be rather large because of the many critical systems and operations to be monitored. This requires in this embodiment a broadband network with high link capacity to backhaul the data. As a 5G network, NTN will provide such broadband links in this embodiment.

In the present embodiment, all the telemetry data from all the subsystems and operations processes of the aircraft 2 are transferred to the VMD 3 (having the function of a telemetry concentration device). The VMD 3 is located within the aircraft 2 and it contains a significant amount of temporary storage provided by a SSD, but also incorporates the same functionality as a high capability terminal device or UE.

The UE functionality of the VMD 3 is used in the present embodiment to offload the vehicle monitoring data (including telemetry data) off board via the relay 4 which is also mounted in the vehicle.

This offload can be continuous or streamed, intermittent at regular intervals or occasionally, triggered for offload by the relay 4, crew or other onboard subsystem, such as the onboard computer 6 (or an emergency/trigger switch, button or the like).

In this embodiment, the data held in the temporary storage of the VMD 3 is compressed using lossless data compression schemes to reduce its bit rate before transmission.

In many embodiments, a continuous streaming of the telemetry data by the VMD 3 may be desirable for many reasons. However, since the VMD 3 will share the backhaul link 9 with passenger data, full-throttle streaming of the vehicle monitoring data may cause congestion on the backhaul link 9 for passenger data.

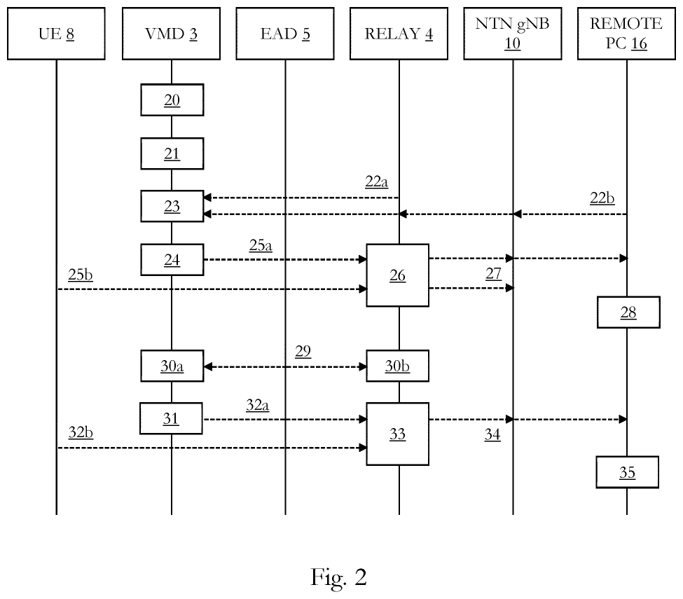

In the following, an overall functionality or method of the vehicle emergency monitoring system 1 and its components will be explained also under reference of FIG. 2, which is a state diagram for the components UE 8, VMD 3, EAD 5, relay 4, NTN gNB 10 and the remote server (PC) 16.

In the present embodiment, the vehicle monitoring data received at 20 can be cached for some time within the VMD 3 and, as mentioned, compressed at 21 for reducing a transmission bit rate.

Typically, the vehicle monitoring data is transmitted for storage to the home station 16 at regular intervals.

However, in specific occasions, it is useful to transmit the vehicle monitoring data also in response to an instruction.

For instance, a transmission command such as a standard resource grant following paging can be transmitted from the relay 4 to the VMD 3 at 22a, such that the VMD 3 transmits in response to receipt of the transmission command the vehicle monitoring data via the relay 4 and the backhaul links 9 and 13 and the network 15 to the home station 16 for storage (and e.g. further analysis).

The transmission command may be triggered, for example, by a crew member, by making an input to the on-board computer 6 or activating a corresponding switch, button or the like, as discussed.

Moreover, there can be an explicit call for data from the home station server 16, as indicated at 22b, where an instruction is transmitted from the home station server 16 to the relay 4, which in turn transmits the transmission command to the VMD 3.

Caching the data within the VMD 3 has the advantage that it allows time for preprocessing (such as for compression or prioritization) of the data onboard prior to transmission, as discussed. It also allows the home station server 16 to request as indicated at 22b particular or specific data for example from a certain subsystem or particular sensor at any time.

The VMD 3 receives the transmission command at 23 and identifies the particular or specific vehicle monitoring data for transmission at 24. For instance, in a prioritization situation as discussed herein, the VMD 3 may provide the prioritized data, or in cases where the vehicle monitoring data is compressed, the compression could be finished, before the data is transmitted, or in cases where specific vehicle monitoring data is requested, the specific data is transmitted etc.

At 25a, the VMD 3 transmits the vehicle monitoring data to the relay 4, which also receives data from the UE 8 transmitted at 25b. In this case, the resources of the backhaul link are sufficient, such that the relay 4 decides at 26 to transmit the vehicle monitoring data and the data from the UE 8 over the backhaul link 9 at 27 to the gNB 10, wherein the vehicle monitoring data are transferred from the gNB 10 to the remote home station server 16, which stores or processes the vehicle monitoring data at 28.

Furthermore, the crew or other emergency detection systems within the aircraft, such as the EAD 5, can trigger an emergency dumping of the vehicle monitoring data (including e.g. telemetry data) at critical times at which point passenger off-board communications may either be stopped or de-prioritized to clear the backhaul link 9 for fast telemetry data dumping, as discussed herein.

The EAD 5 receives the emergency signals from all the emergency detectors/sensors 7 in the aircraft 2 and also, e.g., any emergency input from the crew, which can be done via the on-board computer 6 (or a switch, button, etc.).

The EAD 5 is configured to analyze all the inputs from the various emergency detectors/sensors 7 and any crew input and decide on the basis of these data, whether or not there is an actual life threatening or potential catastrophic emergency or any other critical situation of the aircraft 2.

For its analysis, the EAD 5 uses a decision matrix designed by using machine learning, which is based initially on data from simulated emergencies (such as from flight simulators). Once installed, actual emergency sensor data can be captured and used to fine tune the decision matrix of the deployed EAD 5.

If the EAD 5 decides that there is an actual emergency, it transmits an emergency command at 29 which configures the relay 4 to enable it to down-throttle or cease transmission of passenger off-board data and prioritize data offloading from the VMD 3. As discussed herein, the EAD 5 may also transmit the emergency command to the VMD 3, which, in turn, requests a prioritized transmission from the relay 4 and/or the relay 4 detects that an according prioritization is needed, as discussed herein.

Once triggered by the EAD 5, the gNB side of the relay 4 can achieve this down-throttling by sending a radio link control (RLC) release command to all connected passenger UEs 8 except for the VMD 3 UE and/or execute selective barring of passenger UEs 8. This has the effect of either barring the passenger UEs 8 from the in-aircraft network for a while or down-throttling the transmission resources they use.

As also discussed above, the vehicle monitoring data (including e.g. telemetry data) can be classified or grouped into more than one priority class or group according to its importance. For instance, telemetry originating from the subsystem from which the principal malfunction was detected and any secondary systems affected can be given a higher priority than telemetry from unaffected and unfailing subsystems. In an emergency, this would allow more critical data to be offloaded before less critical data.

At 30a, the VMD 3 receives the emergency command and, analog to 23, it starts at 31 transmitting at 32a the vehicle monitoring data (e.g. according to the current prioritization, if instructed accordingly either by the relay 4 or by the emergency command received from the EAD 5).

At 30b, the relay 4 receives the emergency command and configures itself accordingly to transmit the vehicle monitoring data at 33 including the prioritization procedure discussed above. Here, at 32b the UE 8 transmits data, but the relay 4 prioritizes the vehicle monitoring data at 33 and transmits them at 34, wherein they are received by the home station 16, which stores or processes them at 35.

In another embodiment (not illustrated), to maximize the reliability of critical data transmission during emergency, more resilient transmission configurations such as MCS, data repetition etc., are adopted for transmitting the vehicle monitoring data off board during an emergency. This will maximize the possibility of successful transmission on degraded radio links that may have been compromised by the emergency, such as antenna mis-pointing errors arising from sub-optimum orientation of the vehicle, link degradation from smoke and clouds etc. This can be achieved as follows: typically, in some embodiments, the MCS settings used by a given relay for uplink (UL) transmissions to the donor gNB are configured by the donor gNB in the UL resource grant to the relay. To configure the right settings for the MCS, the donor gNB asks for and receives measurements of the current channel conditions such as channel quality indication (CQI) reported to the donor gNB by the relay. In this embodiment, the relay is configured with a negative CQI offset which it applies to any CQI reports after it receives the emergency command. The consequence of applying this offset to the CQI is the reporting of lower CQI values with the effect of causing the donor gNB to configure more resilient MCS settings for the relay to donor gNB UL.

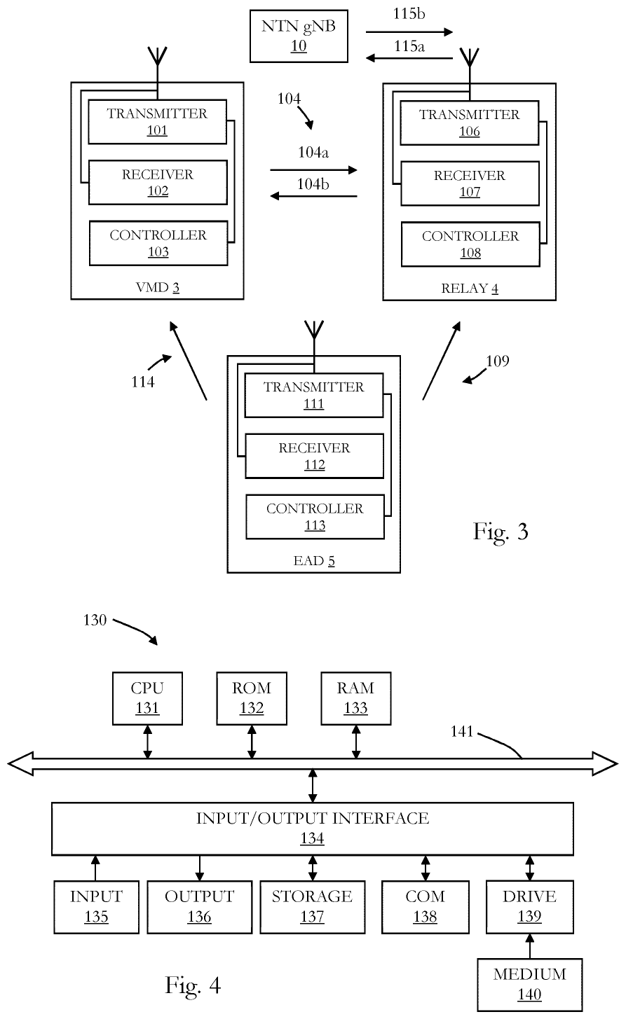

In the following, the VMD 3, the relay 4 and the EAD 5 are discussed in more detail under reference of FIG. 3.

The VMD 3 has a transmitter 101, a receiver 102 and a controller 103 which together from a circuitry of the VMD 3, which is configured to provide the functionality of the VMD 3 as discussed herein (further components, such as a cache are not illustrated, since they are principally known to the skilled person). Generally, the technical functionality of the transmitter 101, the receiver 102 and the controller 103 are known to the skilled person, and, thus, a more detailed description of them is omitted.

The relay 4 has a transmitter 106, a receiver 107 and a controller 108 which together from a circuitry of the relay 4, which is configured to provide the functionality of the relay 4 as discussed herein. Also here, generally, the functionality of the transmitter 106, the receiver 107 and the controller 108 are known to the skilled person, and, thus, a more detailed description of them is omitted.

The EAD 5 has a transmitter 111, a receiver 112 and a controller 113, which together from a circuitry of the EAD 5, which is configured to provide the functionality of the EAD 5 as discussed herein. Also here, generally, the functionality of the transmitter 111, the receiver 112 and the controller 113 are known to the skilled person, and, thus, a more detailed description of them is omitted.

A communication path 104 between the VMD 3 and the relay 4 has an uplink path 104a, which is from the transmitter 101 of the VMD 3 to the gNB side of the receiver 106 of the relay 4, and a downlink path 104b, which is from the gNB side of the transmitter 106 of the relay 4 to the receiver 102 of the VMD 3.

During operation, the controller 103 of the VMD 3 controls the reception of downlink signals over the downlink path 104b at the receiver 102 and the controller 103 controls the transmission of uplink signals over the uplink path 104a via the transmitter 101.

For instance, the VMD 3 transmits the vehicle monitoring data over the uplink path 104a to the relay 104 and receives the transmission or emergency command or other data over the downlink path 104b.

Similarly, during operation, the controller 108 of the relay 4 controls the transmission of downlink signals over the downlink path 104b over the transmitter 106 and the controller 108 controls the reception of uplink signals over the uplink path 104a at the receiver 107.

For instance, the relay 4 receives the vehicle monitoring data over the uplink path 104a and transmits the transmission command, the emergency command or the like over the downlink path 104b.

Similarly, the relay 4 establishes the backhaul link to the NTN gNB 10, which includes a backhaul uplink 115a and a backhaul downlink 115b, wherein the relay 4 can transmit data via the backhaul uplink 115a to the NTN gNB 10 and can received data via backhaul downlink 115b, as also discussed herein.

Moreover, there is communication path 114 between the EAD 5 and the VMD 3 and a communication path 109 between the EAD 5 and the relay 4, over which, for example, the emergency command can be transmitted to the VMD 3 and the EAD 5, respectively.

Alternatively, in some embodiments, in particular, where no (direct) communication link exists between the EAD 5 and the relay 4, the EAD 5 can declare its emergency to the VMD 3 and then the VMD 3 can set a high priority for each emergency protocol data unit (PDU) by executing a scheduling request (SR) to the relay for higher priority logical channels over the network.

During operation, the controller 113 of the EAD 5 controls the receiver 112 also to receive the emergency sensor data from the emergency sensors 7 and to transmit the emergency command over the communication links 114, 109, respectively, to the VMD 3 and the relay 4 (or alternatively, as mentioned above, only to the VMD 3 when no communication link exists between the EAD 5 and the relay 4).

In the following, an embodiment of a general purpose computer 130 is described under reference of FIG. 4. The computer 130 can be implemented such that it can basically function as any type of VMD, relay, EAD, base station or new radio base station, transmission and reception point, or user equipment as described herein. Moreover, the computer 130 may be used for implementing a controller of a UE, a VMD, an EAD, a relay or of a (new radio) base station or any other network entity as described herein.

The computer has components 131 to 140, which can form a circuitry, such as any one of the circuitries of the VMD, the relay, the EAD, the (new radio) base stations, and user equipments, as described herein.

Embodiments which use software, firmware, programs or the like for performing the methods as described herein can be installed on computer 130, which is then configured to be suitable for the concrete embodiment.

The computer 130 has a CPU 131 (Central Processing Unit), which can execute various types of procedures and methods as described herein, for example, in accordance with programs stored in a read-only memory (ROM) 132, stored in a storage 137 and loaded into a random access memory (RAM) 133, stored on a medium 140 which can be inserted in a respective drive 139, etc.

The CPU 131, the ROM 132 and the RAM 133 are connected with a bus 141, which in turn is connected to an input/output interface 134. The number of CPUs, memories and storages is only exemplary, and the skilled person will appreciate that the computer 130 can be adapted and configured accordingly for meeting specific requirements which arise, when it functions as a base station or as user equipment.

At the input/output interface 134, several components are connected: an input 135, an output 136, the storage 137, a communication interface 138 and the drive 139, into which a medium 140 (compact disc, digital video disc, compact flash memory, or the like) can be inserted.

The input 135 can be a pointer device (mouse, graphic table, or the like), a keyboard, a microphone, a camera, a touchscreen, etc.

The output 136 can have a display (liquid crystal display, cathode ray tube display, light emittance diode display, etc.), loudspeakers, etc.

The storage 137 can have a hard disk, a solid state drive and the like.

The communication interface 138 can be adapted to communicate, for example, via a local area network (LAN), wireless local area network (WLAN), mobile telecommunications system (GSM, UMTS, LTE, 5G, NR etc.), Bluetooth, infrared, etc.

It should be noted that the description above only pertains to an example configuration of computer 130. Alternative configurations may be implemented with additional or other sensors, storage devices, interfaces or the like. For example, the communication interface 138 may support other radio access technologies than the mentioned UMTS, LTE, 5G and NR.

When the computer 130 functions as a base station, the communication interface 138 can further have a respective air interface (providing e.g. E-UTRA protocols OFDMA (downlink) and SCFDMA (uplink)) and network interfaces (implementing for example protocols such as S1-AP, GTPU, S1-MME, X2-AP, or the like). Moreover, the computer 130 may have one or more antennas and/or an antenna array. The present disclosure is not limited to any particularities of such protocols.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A vehicle monitoring device, having circuitry configured to communicate with a remote computer through a mobile telecommunications system, wherein the circuitry is further configured to:

transmit vehicle monitoring data to a remote computer, wherein the vehicle monitoring data are transmitted via a relay of the mobile telecommunications system located at the vehicle.

(2) The vehicle monitoring device of (1), wherein the vehicle monitoring data are transmitted continuously or periodically or on command to the remote computer via the relay.

(3) The vehicle monitoring device of (1) or (2), wherein the vehicle monitoring data are transmitted in response to a transmission command to transmit the vehicle monitoring data.

(4) The vehicle monitoring device of (3), wherein the transmission command is received from the relay.

(5) The vehicle monitoring device of (3) or (4), wherein the transmission command is issued by the relay.

(6) The vehicle monitoring device according to anyone of (3) to (5), wherein the transmission command is issued by a remote computer.

(7) The vehicle monitoring device according to anyone of (3) to (6), wherein the transmission command includes an emergency command issued by an emergency arbitration device.

(8) The vehicle monitoring device according to anyone of (3) to (7), wherein the transmission command is issued by a vehicle-based device.

(9) The vehicle monitoring device of anyone of (1) to (8), wherein the circuitry is further configured to perform data compression on the vehicle monitoring data.

(10) The vehicle monitoring device of anyone of (1) to (9), wherein the vehicle monitoring data includes at least one of: sensor data from vehicle sensors, voice recording data, positioning data, image data.

(11) The vehicle monitoring device of anyone of (1) to (10), wherein the vehicle is an aircraft, a ship, a train, a drone, a submarine, a bus, or a coach.

(12) The vehicle monitoring device of anyone of (1) to (11), wherein the circuitry is configured to store the vehicle monitoring data until transmission of the vehicle monitoring data.

(13) The vehicle monitoring device of (12), wherein the circuitry includes a data cache, wherein the capacity of the data cache is adapted to the transmission of the vehicle monitoring data.

(14) The vehicle monitoring device of anyone of (1) to (13), wherein the circuitry is further configured to divide the vehicle monitoring data into at least two vehicle monitoring data groups.

(15) The vehicle monitoring device of (14), wherein the circuitry is further configured to prioritize at least one of the at least two vehicle monitoring data groups for transmission.

(16) The vehicle monitoring device of (15), wherein the circuitry transmits the prioritized vehicle monitoring data group based on an access link quality to the relay.

(17) The vehicle monitoring device of anyone of (15) to (16), wherein the circuitry transmits the prioritized vehicle monitoring data group in response to a prioritization command received from the relay or the remote computer.

(18) A relay having circuitry configured to communicate with a mobile telecommunications system, wherein the circuitry is further configured to:
establish a mobile communication backhaul link to the mobile telecommunications system;
provide mobile telecommunication to a vehicle monitoring device and at least one user equipment located at the vehicle; and
transmit vehicle monitoring data received from the monitoring device and transmission data received from the at least one user equipment to the mobile telecommunications system over the backhaul link.

(19) The relay of (18), wherein the circuitry is further configured to prioritize the vehicle monitoring data for transmission over the backhaul link.

(20) The relay of (19), wherein the prioritization is performed on the basis of an emergency command.

(21) The relay of (20), wherein the emergency command is received from an emergency arbitration device.

(22) The relay according to anyone of (20) to (21), wherein the emergency command is received from a vehicle-based device.

(23) The relay according to anyone of (19) to (22), wherein the prioritization is performed on the basis of a backhaul link quality.

(24) The relay according to anyone of (19) to (23), wherein the circuitry is further configured to limit transmission resources for the at least one user equipment during an emergency.

(25) The relay of (24), wherein the circuitry is further configured to send a radio link control command to the at least one user equipment for throttling-down or stopping transmissions of the at least one user equipment.

(26) The relay of anyone of (18) to (25), wherein the circuitry is further configured to switch a transmission configuration for the backhaul link.

(27) The relay of (26), wherein the transmission configuration includes modulation and coding settings configuration or a data repetition configuration.

(28) The relay of (18) or according to anyone of (26) to (27), wherein the switching is performed in response to an emergency command.

(29) The relay of (18), wherein the circuitry is further configured to transmit a transmission command to the vehicle monitoring device.

(30) The relay of (18) or (29), wherein the circuitry is further configured to transmit a prioritization command to the vehicle monitoring device.

(31) The relay of (18) or according to anyone of (29) to (30), wherein the backhaul link is established to an entity of a non-terrestrial network.

(32) An emergency arbitration device having circuitry configured to:
receive emergency sensor data from at least one emergency sensor mounted at a vehicle;
generate an emergency command based on the received sensor data; and
provide the emergency command, such that the relay prioritizes vehicle monitoring data for transmission over a backhaul link established to a mobile telecommunications system.

(33) The emergency arbitration device of (32), wherein the circuitry is further configured to determine an emergency situation based on the received sensor data and wherein the emergency command is generated when an emergency situation is determined.

(34) The emergency arbitration device of (33), wherein the determination is based on a decision matrix.

(35) The emergency arbitration device of (34), wherein the decision matrix is obtained based on machine learning.

(36) The emergency arbitration device of (35), wherein the decision matrix is obtained based on flight simulator data.

(37) The emergency arbitration device of (36), wherein the decision matrix is adapted based on vehicle data.

(38) The emergency arbitration device according to anyone of (32) to (37), wherein the circuitry is further configured to transmit the emergency command to the vehicle monitoring device.

(39) A vehicle emergency monitoring system, having:
a vehicle monitoring device, in particular according to anyone of (1) to (17), having circuitry configured to communicate with a mobile telecommunications system, wherein the circuitry is further configured to:
transmit vehicle monitoring data to a remote computer, wherein the vehicle monitoring data are transmitted via a relay of the mobile telecommunication system located at the vehicle; and
the relay, in particular according to anyone of (18) to (31), having circuitry configured to communicate with a mobile telecommunications system, wherein the circuitry is further configured to:
establish a mobile communication backhaul link to the mobile telecommunications system;
provide mobile telecommunication to the vehicle monitoring device and at least one user equipment located at the vehicle; and
transmit vehicle monitoring data received from the monitoring device and transmission data received from the at least one user equipment to the mobile telecommunications system over the backhaul link.

(40) The vehicle emergency monitoring system of (39), further having an emergency arbitration device, in particular according to anyone of (32) to (38), having circuitry configured to:
receive emergency sensor data from at least one emergency sensor mounted at the vehicle;
generate an emergency command based on the received sensor data; and
provide the emergency command to the relay, such that the relay prioritizes vehicle monitoring data for transmission over the backhaul link.

1. A vehicle monitoring device, comprising circuitry configured to communicate with a remote computer through a mobile telecommunications system, wherein the circuitry is further configured to:
transmit vehicle monitoring data to a remote computer, wherein the vehicle monitoring data are transmitted via a relay of the mobile telecommunications system located at the vehicle.

2. The vehicle monitoring device of claim 1, wherein the vehicle monitoring data are transmitted continuously or periodically or on command to the remote computer via the relay.

3. The vehicle monitoring device of claim 1, wherein the vehicle monitoring data are transmitted in response to a transmission command to transmit the vehicle monitoring data.

4. The vehicle monitoring device of claim 3, wherein the transmission command is received from the relay.

5. The vehicle monitoring device of claim 3, wherein the transmission command is issued by the relay.

6. The vehicle monitoring device of claim 3, wherein the transmission command is issued by a remote computer.

7. The vehicle monitoring device of claim 3, wherein the transmission command includes an emergency command issued by an emergency arbitration device.

8. The vehicle monitoring device of claim 3, wherein the transmission command is issued by a vehicle-based device.

9. The vehicle monitoring device of claim 1, wherein the circuitry is further configured to perform data compression on the vehicle monitoring data.

10. The vehicle monitoring device of claim 1, wherein the vehicle monitoring data includes at least one of: sensor data from vehicle sensors, voice recording data, positioning data, image data.

11. The vehicle monitoring device of claim 1, wherein the vehicle is an aircraft, a ship, a train, a drone, a submarine, a bus, or a coach.

12. The vehicle monitoring device of claim 1, wherein the circuitry is configured to store the vehicle monitoring data until transmission of the vehicle monitoring data.

13. The vehicle monitoring device of claim 12, wherein the circuitry includes a data cache, wherein the capacity of the data cache is adapted to the transmission of the vehicle monitoring data.

14. The vehicle monitoring device of claim 1, wherein the circuitry is further configured to divide the vehicle monitoring data into at least two vehicle monitoring data groups.

15. The vehicle monitoring device of claim 14, wherein the circuitry is further configured to prioritize at least one of the at least two vehicle monitoring data groups for transmission.

16. The vehicle monitoring device of claim 15, wherein the circuitry transmits the prioritized vehicle monitoring data group based on an access link quality to the relay.

17.-31. (canceled)

32. An emergency arbitration device comprising circuitry configured to:
receive emergency sensor data from at least one emergency sensor mounted at a vehicle;
generate an emergency command based on the received sensor data; and
provide the emergency command, such that the relay prioritizes vehicle monitoring data for transmission over a backhaul link established to a mobile telecommunications system.

33. The emergency arbitration device of claim 32, wherein the circuitry is further configured to determine an emergency situation based on the received sensor data and wherein the emergency command is generated when an emergency situation is determined.

34.-38. (canceled)

39. A vehicle emergency monitoring system, comprising:
a vehicle monitoring device, comprising circuitry configured to communicate with a mobile telecommunications system, wherein the circuitry is further configured to:
transmit vehicle monitoring data to a remote computer, wherein the vehicle monitoring data are transmitted via a relay of the mobile telecommunication system located at the vehicle; and
the relay comprising circuitry configured to communicate with a mobile telecommunications system, wherein the circuitry is further configured to:
establish a mobile communication backhaul link to the mobile telecommunications system;
provide mobile telecommunication to the vehicle monitoring device and at least one user equipment located at the vehicle; and
transmit vehicle monitoring data received from the monitoring device and transmission data received from the at least one user equipment to the mobile telecommunications system over the backhaul link.

40. The vehicle emergency monitoring system of claim 39, further comprising an emergency arbitration device comprising circuitry configured to:
receive emergency sensor data from at least one emergency sensor mounted at the vehicle;
generate an emergency command based on the received sensor data; and
provide the emergency command to the relay, such that the relay prioritizes vehicle monitoring data for transmission over the backhaul link.
